(19) United States
(12) Patent Application Publication
(10) Pub. No.: US 2012/0025566 A1
(43) Pub. Date: Feb. 2, 2012

(54) Self-Tearing Interior Wrap

(75) Inventors: Aaron S. Wisniewski, Plymouth, MI (US); Robert R. Chimelak, Warren, MI (US)

(73) Assignee: FAURECIA INTERIOR SYSTEMS INC., Auburn Hills, MI (US)

(21) Appl. No.: 12/844,397

(22) Filed: Jul. 27, 2010

(51) Int. Cl. B62D 29/04; B32B 3/26

(52) U.S. Cl. 296/191; 428/304.4; 428/314.4

(57) ABSTRACT

A self-tearing wrap and methods for its manufacture are disclosed, the wrap being useful for incorporation onto interior trim panels. The wrap includes an unscored skin such as leather affixed to a foam layer made of an open or closed cell foam material having specific properties. Interior trim panels including the self-tearing leather wrap may include weakened substrates operable to facilitate the deployment of an airbag.

### FIELD OF THE INVENTION

The present invention relates generally to the interior of vehicles and their method of manufacture, and more particularly, to interior panels of a vehicle, such as may be disposed on a door, dashboard, seat, ceiling, sidewall, instrument panel, center console and other trim panels.

### BACKGROUND OF THE INVENTION

Automobile interiors typically have a decorative skin, such as fabric or leather, with an underlying support structure or substrate. Interposed between the skin and substrate is typically a cloth or mesh spacer to provide added softness to the decorative skin. A significant drawback of the cloth or mesh spacer is that it is too weak to maintain its shape if parts are cut out, for example, for various profiles. Because of this drawback, designers have limited aesthetic and functional design options available. For example, sharp edges or small radii in panels are avoided because the relatively weak cloth or mesh at corners becomes misshaped and compressed. Also, because of the compression, a panel using cloth spacers and having small radii exhibits a harder and less desirable feel.

The current trend for many luxury vehicles is to pressure bond a thick leather skin with a spacer material to the instrument panel. This bonding process presents several drawbacks, including difficulties in bonding leather to the spacer material or to the carrier and aesthetic problems such as lack of smoothness and uniformity. The scrap rate is very high and costly. Furthermore, since a decorative skin made of a thick leather sheet, typically from 1.0 to 1.5 mm in thickness, does not allow the deployment of an airbag unless the decorative skin is weakened, a score line is often employed. However, when the decorative skin is scored, a witness line, known as “read-through,” can be observed opposite the side that was weakened, resulting in non-desirable aesthetics.

The spacer material that is typically used also presents several problems. Standard spacer materials typically have a tear strength greater than 70N (ISO 13937-2) and may be as high as 500N (ISO 13937-2), and are difficult to laser score due to non-homogeneity of the material. Moreover, the typical materials used cause surface defects and a high scrap rate.

It is also problematic to bond thin leather skin alone to the entire surface of the instrument panel, since doing so results in all surface defects from dust, adhesive, etc. showing through the thin leather skin. Adding a typical spacer fabric would require the laser scoring of the carrier and spacer fabric. The result would be undesirable “A” surface read-through from the weakening.

Thus there is a need for improved leather wrap materials and a method to improve perceived quality and reduce total cost of the bonding a soft leather to an instrument panel.

### SUMMARY OF THE INVENTION

In accordance with aspects of the present invention, a self-tearing interior wrap for vehicles and methods of manufacture are disclosed. The self-tearing interior wrap is especially suited for use as a decorative trim panel, such as may be disposed on a door, dashboard, seat, ceiling, sidewall, instrument panel, center console, etc., in passenger automobiles and trucks.

In accordance with one embodiment, a self-tearing wrap material includes a thin skin and a soft foam material of specified dimensions, wherein neither the skin nor the foam material is weakened, such as is commonly achieved by scoring or the like. Skin thickness is less than 1.0 mm and may range from about 0.3 mm to 0.9, more preferably from about 0.3 mm to 0.55 mm, and most preferably about 0.4 mm. Skin of such thickness can be considered and is defined herein as “self-tearing”.

In one embodiment, a soft foam material, which may be an open or closed cell foam, having a tear strength of about 9N to about 32N according to JIS K6767, elongation of 200% to 450% (JIS K6767), density of 2 to 6 lb./cu. ft. (JIS K6767), and thickness of 1.0 mm to 4.0 mm (JIS K6767), is employed. In one embodiment the foam is a polypropylene foam. It will be apparent to a skilled artisan that any suitable foam may be employed, such as polyurethane, PVC foam and the like. The foam preferably permits hand wrapping of the perimeter and corners.

The combination of thin skin and foam having the aforementioned characteristics provides a self-tearing wrap for an instrument panel whereby only the substrate carrier needs to be scored for seamless airbag deployments.

This wrap may be advantageously cut and sewn to any desirable width and length. The foam layer may be skived to hold virtually any desirable profile. The wrap is preferably wrapped onto a substrate and adhered by an adhesive, the substrate typically being made of plastic. This wrap is then incorporated into a vehicle as a panel or trim. The panel may also have a protective airbag affixed thereto. Surprisingly, the self-tearing skin and foam layer provide an aesthetically acceptable wrap without the need for weakening the wrap when used in conjunction with a pre-weakened substrate for facilitating airbag deployment.

Methods of producing a self-tearing wrap for an interior trim panel are also disclosed in further aspects of the invention. One such method commences with receiving a thin outer leather skin having a thickness of less than 1.0 mm and a foam layer having a thickness of about 4.0 mm or less. The outer skin which may be leather is adhered to the foam layer and the foam layer is skived to suit a desired profile. It can be appreciated that the foam layer and/or the leather skin can also be skived prior to adhering it to the outer skin. Based on measurements associated with a selected profile, a skiving machine with an appropriate blade is employed for this procedure. The bilaminate wrap is not weakened before it is applied to the substrate.

Another aspect relates to a method of manufacturing an interior trim panel employing the self-tearing wrap. The method comprises receiving a substrate and a self-tearing wrap material, applying adhesives and adhering the wrap to the substrate. The wrap comprises a foam layer that is skived into a desired profile based on measurements related to the profile. For example, the foam layer can be skived to a thickness that matches an area interposed between the thin outer skin and the substrate. As the foam layer is made up of a non-porous material it can hold a shape regardless of the thickness of the material removed from it due to skiving. The substrate is weakened to facilitate airbag deployment. The self-tearing leather skin/soft foam wrap, which is not scored, is bonded to the weakened substrate for a vehicle instrument panel to facilitate deployment of airbags while mitigating the appearance of read through on the A-surface. It will be appreciated that in accordance with this embodiment only the substrate carrier would require weakening for seamless airbag deployment.

The foregoing embodiments provide a soft leather skin with high perceived quality through superior tactile feel when pressed upon. The thinner the leather, the greater the improvement in touch and feel softness, due to the greater effect on feel of the foam. The foregoing embodiments eliminate scoring of the skin and/or foam. In addition, there is realized a lower cost weakening method for the carrier substrate.

### BRIEF DESCRIPTION OF THE DRAWINGS

FIG. 1 is a schematic depicting a skin, foam layer and substrate construction in accordance with one or more embodiments of the present invention.

FIG. 2 is a flow diagram of a method to produce a self-tearing interior wrap in accordance with one or more embodiments of the present invention.

FIG. 3 is a flow diagram of a process to produce a self-tearing interior wrap in accordance with one or more embodiments of the present invention.

FIG. 4 is a flow diagram of a process of making an interior trim panel in accordance with one or more embodiments of the present invention.

FIG. 5 is another flow diagram detailing a sub process involved in the manufacture of the interior trim panel.

### DETAILED DESCRIPTION

In the following description, for purposes of explanation, specific numbers, materials and configurations are set forth to provide a thorough understanding of the invention. It will be apparent to one having ordinary skill in the art that the invention may be practiced without these specific details. In some instances, well-known features may be omitted or simplified so as not to obscure the present invention.

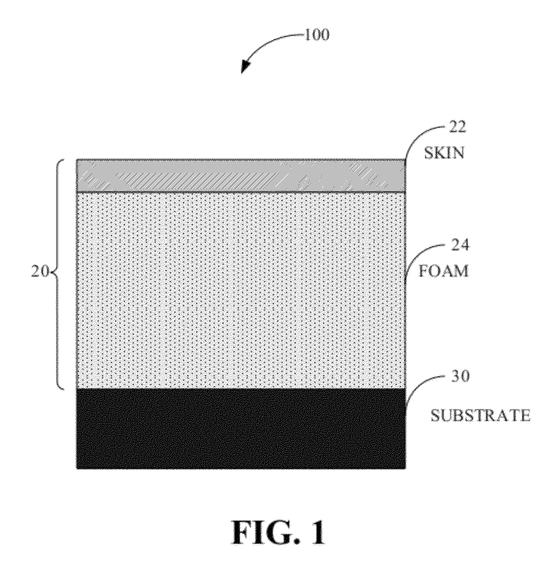

Turning now to the drawings, FIG. 1 shows a sectional view of an interior trim panel 100 employing the self-tearing interior wrap 20 of an embodiment in accordance with the present disclosure, including a thin outer skin 22, a foam layer 24 and a substrate 30. The skin 22 is attached to the foam layer 24 using, for example, an adhesive or flame bonding. The self-tearing interior wrap 20 is attached to the substrate 30, for example, using an adhesive. The substrate 30 forms the base for the structure of the interior trim panel 100. The skin 22 can be any suitable leather or imitation leather material such as but not limited to imitation leather formed from thermoplastic polyolefin (TPO), polyvinyl chloride (PVC) or polyurethane (PU). The thickness of skin 22 may range from about 0.3 mm to about 0.9 mm, more preferably from about 0.3 mm to 0.55 mm, and most preferably about 0.4 mm. The skin 22 may be approximately one-half as thick as the skin of conventional leather wrap materials.

The foam layer 24 can comprise an open or closed-cell, non-porous foam structure, which results in a less absorbent, firmer material that may permit skiving various profiles therein. In one embodiment, the foam layer 24 has a tear strength of about 9N to about 32N according to JIS K6767, elongation of 200% to 450% (JIS K6767) and density of 2 to 6 lb./cu. ft. (JIS K6767). Foam layer 24 having the aforementioned properties at the thicknesses disclosed herein may be considered self-tearing. Foam having the foregoing properties is commercially available from Toray Plastics of Front Royal, Va. In one embodiment the foam layer 24 comprises a polypropylene foam having the aforementioned properties. It will be apparent to a skilled artisan that any suitable foam may be employed, such as polyurethane, PVC foam and the like. The thickness of the foam layer 24 may range from about 1.0 mm to about 4.0 mm, more preferably from about 2.0 mm to 3.5 mm, and most preferably from about 2.5 mm to 3.0 mm.

It will be apparent to those having skill in the art that the self-tearing interior wrap 20 may include multiple foam layers 24, which may be of the same or different type.

The total thickness of the self-tearing interior wrap may be from about 1.3 mm to less than about 5.0 mm, more preferably from about 2.3 mm to about 4.05 mm, and most preferably from about 2.9 mm to about 3.4 mm. Leather of the foregoing thicknesses is obtainable using a leather splitting machine as is known in the art. Such leather may also be obtained commercially from Spinneybeck of Getzville, N.Y.

The thin skin 22 of embodiments of the present disclosure facilitates eliminating the need to weaken the skin 22 and/or foam layer 24, for example, for a stress concentrator providing a path for the initiation and propagation of a tear when used in conjunction with a protective airbag. Improved aesthetics result because no read-through witness lines can be observed on the resultant decorative trim or panel. Other advantages include that topcoats and other surface treatments may be used on the skin 22 to provide greater tactile and aesthetic characteristics.

Another design advantage made possible through aspects of the present disclosure is that the foam layer 24 can comprise a closed-cell or non-porous structure, which results in a less absorbent material. This permits the use of less adhesive when wrapping the self-tearing interior wrap 20 to the substrate 30 during manufacturing. A further advantage is realized in that less material is used in making the presently disclosed bilaminate thin leather wrap. Moreover, because no score lines are required, significant process efficiencies are realized due to reduced tooling and processing. In sum, embodiments of the present disclosure provide a cost-effective alternative to standard leather wrap materials.

In accordance with one aspect of the present disclosure, the foam layer 24 can be skived to any desirable profile while maintaining its shape and strength. In a further aspect, the measurements of the profile to be skived into the foam layer 24 can be obtained and the foam layer 24 can be skived in accordance with such measurements. Various profiles in the foam layer 24 can be obtained by using different blades on a skiving/milling machine.

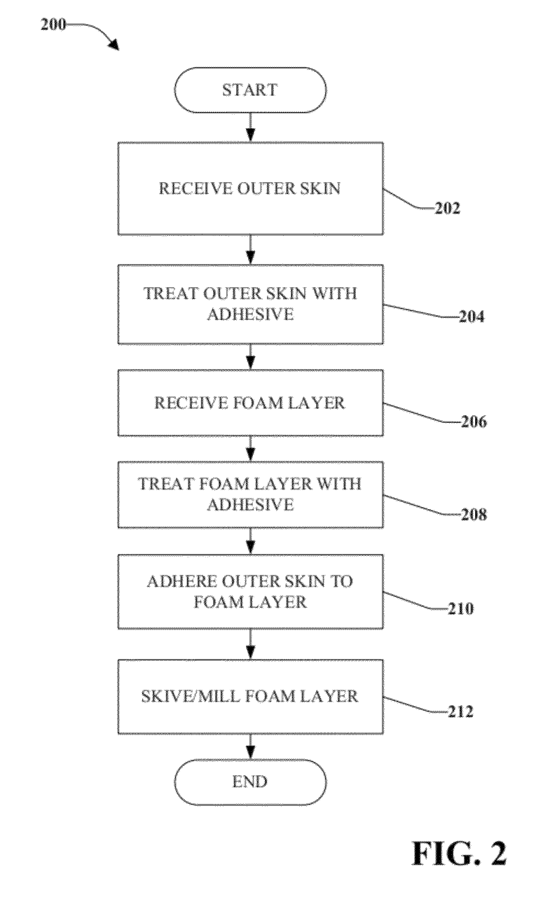

FIG. 2 is a flow diagram that details a process 200 to produce the self-tearing interior wrap 20 in accordance with an aspect of the present disclosure. The procedure 200 begins at 202 wherein an outer skin is received. By the way of illustration and not limitation, while it is disclosed that a skin roll is received, it can be understood that skin cut into different contours, for example, using a cutting table, can also be used in this process. In accordance with an aspect of the invention, the outer skin is made of leather and has a thickness less than 1.0 mm, hence it is thinner than leather skins conventionally used for interior trim panels. At 204, the outer skin is treated with adhesive on its back surface. In a more detailed aspect based on the type of adhesive used, the process 200 may comprise an optional step of drying the adhesive on the outer skin prior to adhering it to the foam layer. Such a step may be employed in an embodiment wherein the adhesive is a water-based adhesive. At 206, a foam layer to be adhered to the skin is received. As mentioned supra, the foam layer can be a closed cell, non-porous material so that it does not absorb a large quantity of adhesive. In step 208 adhesive may be delivered to the surface of the foam layer (for example, by spraying, pouring, depositing, etc.) prior to adhering it to the outer skin layer. At 210, the foam layer is adhered to the outer skin to form a bilaminate. At 212, the foam layer is skived in accordance with a desired profile.

Various contours can be milled/skived into the foam using different blades on the skiving machine. For example, if the outer skin is received as a roll at step 202, different templates can be cut from the resulting bilaminate and sewn together to fit a desired part. If various templates of the outer skin are received at step 202, they may be sewn together after skiving the foam at 212 so that the resulting sewn pieces maintain a uniform profile. In such case, the foam can be partially skived with gradually varying thickness from an outer edge to the inner surface. The leather skin material permits thin constructions and the use of skiving to incorporate various profiles of variable thicknesses into the panels, resulting in reduced manufacturing costs, an increase in the amount of design possibilities, more attractive aesthetics and improved tactile characteristics.

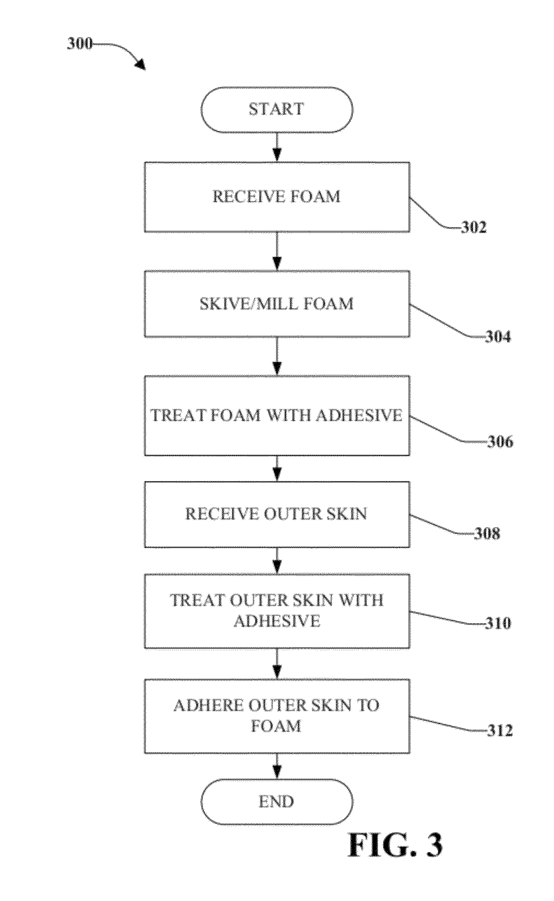

FIG. 3 is a flow chart detailing a process 300 of producing the bilaminate in accordance with another aspect of the present disclosure. The process 300 begins at 302 wherein the foam to be used in the bilaminate is received. At 304, the foam is skived to suit a desired profile. At 306, the skived foam is treated with an adhesive and based on the type of adhesive used, an optional step of drying the adhesive may be included in the process 300. At 308, the skin is received. The skin can be received either as a roll or cut into one or more templates. At 310, the skin is optionally also treated with the adhesive and at 312, the skin is adhered to the skived foam. As mentioned supra, if the outer skin is received in the form of different templates that may be sewn together, the foam can be skived to suit a profile wherein its thickness gradually varies from the outer edges to an inner surface so that the resulting sewn pieces of the bilaminate maintain a uniform profile. The template pieces may be sewn together either solely with a functional seam or they can be sewn together to include a functional and a decorative seam in accordance with different aspects.

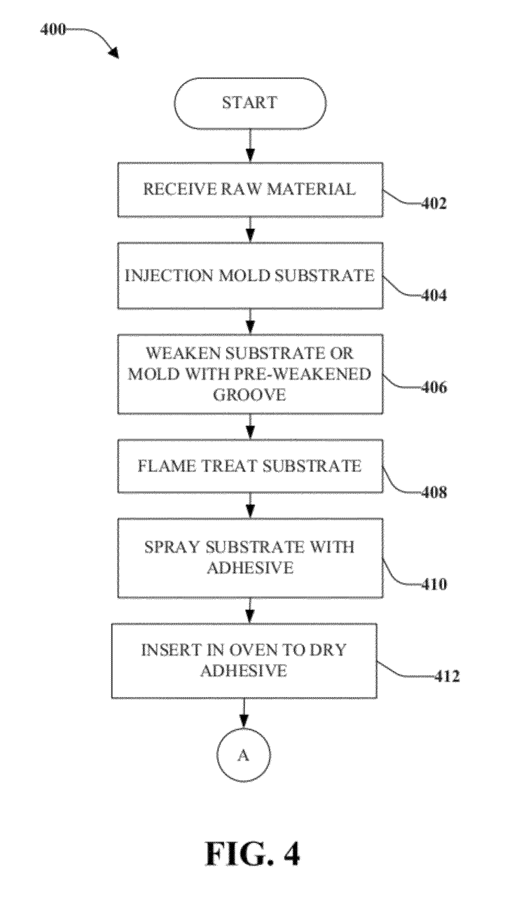

FIG. 4 is another flow chart detailing some of the manufacturing steps involved in making an interior trim panel in accordance with the present disclosure. More particularly, the process 400 details the steps involved in preparing the substrate material for producing the interior trim panel. The process flow begins at 402 with receiving raw material for the substrate from the supplier. The raw material is injection molded into a substrate that forms a structure for an interior trim panel as shown at 404. Based on the location of the trim panel in an interior, various optional steps can be involved in this process. For example, if the trim panel being produced is part of a door panel, then considerations such as air bag ejection etc. may not be necessary. If the trim panel is part of an instrument panel, then the substrate is fashioned to facilitate ejection of the air bags when needed. Therefore, the substrate is weakened as shown at 406. For example, the substrate may be weakened via scoring or perforation by means of a device such as but not limited to a laser, hot knife, milling or by an alternative method known to those having skill in the art. The substrate may be molded with a pre-weakened groove. When an air bag is deployed it can break through the weakened substrate and tear through the self-tearing interior wrap. Subsequently, the substrate material is optionally flame treated at 408. This step is contemplated for materials such as olefinic substrates. According to this procedure, the top layer of the substrate is heated to allow it to be firmly bonded with other materials such as the foam layer. An adhesive is applied to the substrate as shown at 410 such as by spraying, roll application or the like. Based on the type of adhesive used, the substrate may subjected to a drying process to dry the adhesive. The substrate is then ready to be bonded to a material to produce an interior trim panel. In accordance with different aspects, the substrate is bonded to a foam layer alone or a bilaminate structure as described herein. The connector A denotes further steps of processing the substrate as detailed infra.

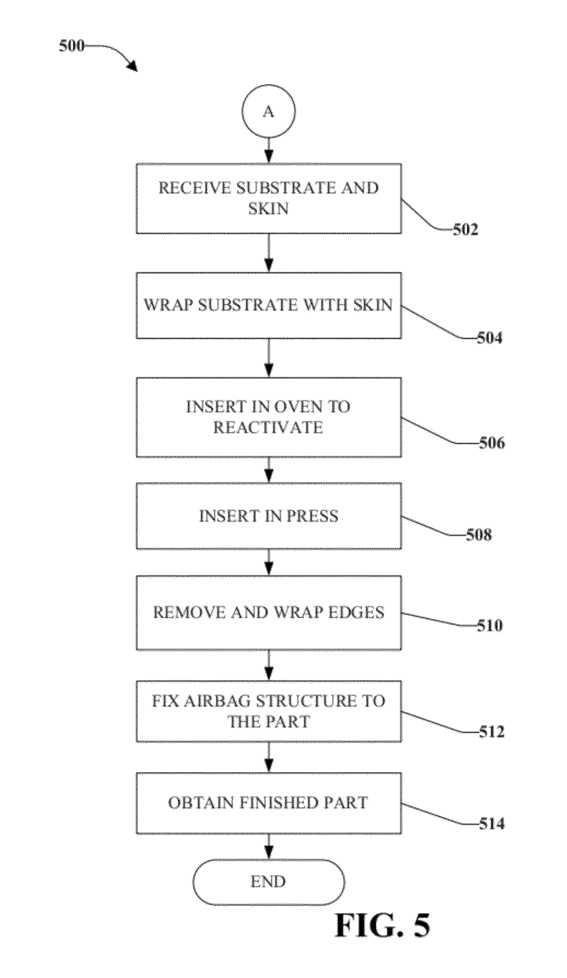

FIG. 5 is another flow diagram detailing a sub process involved in the manufacture of a interior trim panel employing the self-tearing interior wrap disclosed herein. The procedure begins at 502 wherein the substrate from the process detailed in FIG. 4 and a self-tearing interior wrap in accordance with the embodiments described herein are received. At 504 the substrate is wrapped with the self-tearing interior wrap by placing it in contact with the foam layer of the self-tearing interior wrap. A heat gun can be employed for firmly wrapping the substrate with the self-tearing interior wrap. If the self-tearing interior wrap comprises a foam layer skived to suit the contours on the substrate, hand wrapping the self-tearing interior wrap is easier and results in a structure with smooth finish but which maintains requisite firmness. At 506, the substrate with the self-tearing interior wrap wrapped onto it is placed in an oven to activate the entire adhesive. It is then moved to a press, such as a die or bladder press, as shown at 508 which creates a pressure to firmly bond the skin to the substrate. Upon removal from the press, the extraneous edges of the skin that may be loose are firmly wrapped to the substrate using a heat gun as shown at 510. If the trim panel resulting from this procedure is meant for a part of the interior such as an instrument panel, an optional step of fitting the resulting structure with air bags follows as shown at 512 and the finished part with or without the air bags is obtained at 514. The process subsequently terminates on the end block.

It will be noted that the self-tearing interior wrap obtained from various procedures detailed herein can be cut and sewn with other materials, bilaminates, or other structures, for example, compact sheet materials, to form integrated interior panels, with or without skiving of the foam layer. It is important to note that the foregoing steps for different procedures detailed herein do not recite the use of a scoring or weakening process on the self-tearing interior wrap but rather only the substrate material, which is weakened to facilitate ejection of the airbags.

Although preferred embodiments of the invention are disclosed for illustrative purposes, those skilled in the art will appreciate that many additions, modifications, and substitutions are possible without departing from the scope and spirit of the invention.

What is claimed is:

1. A self-tearing wrap for an interior panel, comprising:
a self-tearing skin layer for forming the outer surface of an interior panel, wherein the self-tearing skin layer is not scored; and
at least one foam layer affixed to a surface of the self-tearing skin layer.

2. The self-tearing wrap according to claim 1 wherein the self-tearing skin has a thickness of less than 1.0 mm.

3. The self-tearing wrap according to claim 1 wherein the self-tearing skin has a thickness in the range of from about 0.3 mm to about 0.9 mm.

4. The self-tearing wrap according to claim 1 wherein the self-tearing skin has a thickness in the range of from about 0.3 mm to about 0.55 mm.

5. The self-tearing wrap according to claim 1 wherein the self-tearing skin has a thickness of about 0.4 mm.

6. The self-tearing wrap according to claim 1 wherein the self-tearing skin is leather.

7. The self-tearing wrap according to claim 1 wherein the self-tearing skin is imitation leather made from a material selected from the group consisting of thermoplastic polyolefin (TPO), polyvinyl chloride (PVC) and polyurethane (PU).

8. The self-tearing wrap according to claim 1 wherein the foam layer comprises open or closed cell foam, having a tear strength of about 9N to about 32N, elongation of 200% to 450%, density of 2 to 6 lb./cu. ft., and thickness of 1.0 mm to 4.0 mm.

9. The self-tearing wrap according to claim 1 wherein the foam layer is selected from the group consisting of polypropylene foam, a polyurethane foam, and a PVC foam.

10. The self-tearing wrap according to claim 1 wherein the foam layer comprises polypropylene foam.

11. The self-tearing wrap according to claim 1 wherein the foam layer has a thickness of about 2.5 mm to about 3.0 mm.

12. An interior panel for an automobile comprising the self-tearing wrap according to claim 1, further comprising a substrate supporting the foam layer.

13. The interior panel of claim 12, wherein the substrate comprises a weakened region to facilitate deployment of an airbag.

14. The interior panel of claim 13, wherein the weakened region of the substrate comprises perforations.

15. The interior panel of claim 13, wherein the weakened region of the substrate comprises score lines.

16. The interior panel of claim 12, wherein the substrate is an olefin-based substrate.

17. A method of manufacturing an interior trim panel, comprising:
receiving a self-tearing wrap material comprising a self-tearing skin layer for forming the outer surface of an interior panel, wherein the self-tearing skin layer is not scored and at least one foam layer affixed to a surface of the self-tearing skin layer, and
wrapping a substrate with the self-tearing wrap material.

18. The method of claim 17, further comprising weakening the substrate to facilitate deployment of an airbag.

19. The method of claim 17, further comprising delivering adhesive to the foam layer of the self-tearing wrap material and/or delivering adhesive to the substrate prior to the step of wrapping.

20. A method of producing a self-tearing wrap for an interior panel, comprising:
receiving an unscored self-tearing skin layer and a foam layer; and
affixing the unscored self-tearing skin layer to the foam layer.

21. The method of claim 20 further comprising treating one or more of the unscored self-tearing skin layer or the foam layer with an adhesive.
